(19) United States
(12) Patent Application Publication
(10) Pub. No.: US 2021/0094206 A1
(43) Pub. Date: Apr. 1, 2021

(54) METHOD OF FABRICATING LIGHT-TRANSMITTING BLOOD VESSEL MODEL

(71) Applicant: NATIONAL CHENG KUNG UNIVERSITY, Tainan City (TW)

(72) Inventors: Chia-Yuan CHEN, TAINAN CITY (TW); KARTHICK MANI, TAINAN CITY (TW); Bing-Siou DU, TAINAN CITY (TW)

(21) Appl. No.: 16/689,119

(22) Filed: Nov. 20, 2019

(30) Foreign Application Priority Data
Sep. 27, 2019 (TW) 108135255

(51) Int. Cl. B29C 33/38; B33Y 80/00

(52) U.S. Cl. CPC B29C 33/3842; B29L 2031/40; B29K 2883/00; B33Y 80/00

(57) ABSTRACT

A method for fabricating a light-transmitting blood vessel model is provided and comprises steps of: providing a male mold; performing a female mold forming step to form a female mold on an outer surface of the male mold, wherein the female mold forming step comprises: performing an adhesion step such that the female mold solution is adhered onto the outer surface of the male mold, wherein the adhesion step is a dipping step or a spraying step; performing a drying step of drying the female mold solution on the outer surface of the male mold; and repeating the adhesion step and the drying step for 3 to 4 times to form the female mold; and dissolving the male mold by a solution to cause the remaining female mold to form the light-transmitting blood vessel model. A simulated blood vessel model can be formed by the method.

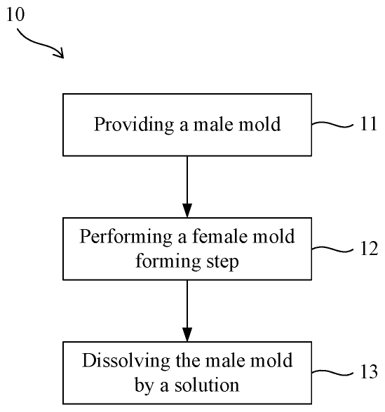

### CROSS REFERENCE TO RELATED APPLICATION

This application claims priority to Taiwan Patent Application No. 108135255, filed on Sep. 27, 2019, which is incorporated herein by reference in its entirety.

### FIELD OF DISCLOSURE

The present disclosure relates to a method of fabricating a model, and more particularly to a method of fabricating a light-transmitting blood vessel model.

### BACKGROUND OF DISCLOSURE

Currently, methods for obtaining information about blood vessels typically use a patient's computed tomography (CT) image to reconstruct a blood vessel model, and then use computer software to simulate distribution of intravascular physical properties (blood velocity, blood pressure, and stress in the vessel wall, etc.), so as to assess a risk of cardiovascular disease. For example, an article published in Annals of Biomedical Engineering in May 2011, entitled “hemodynamics of the hepatic venous three-vessel confluences using particle image velocimetry (Lara M, Chen C Y et al.)”.

In general, a simulation performed by a computer simulation software is simulated under ideal physical conditions. However, the ideal conditions are usually different from actual conditions, resulting in a large difference between the simulation results and the actual results. Therefore, it is necessary to provide a method of fabricating a light-transmitting blood vessel model to solve problems in a conventional technology.

### SUMMARY OF DISCLOSURE

An object of the present disclosure is to provide a method fabricating a light-transmitting blood vessel model, which is fabricated by a specific fabricating method such as dipping or spraying to form a blood vessel model entity having a three-dimensional structure, such that physical properties of the light-transmitting blood vessel model (e.g., vascular elasticity and shrinkage ratio) are similar or identical to actual blood vessels.

To achieve the above object, the present disclosure provides a method of fabricating a light-transmitting blood vessel model, comprising steps of: providing a male mold, wherein a shape of the male mold corresponds to an inner space of a blood vessel; performing a female mold forming step to form a female mold on an outer surface of the male mold, wherein a shape of the female mold corresponds to a shape of the blood vessel, wherein the female mold forming step comprises: performing an adhesion step such that the female mold solution is adhered onto the outer surface of the male mold, wherein the adhesion step is a dipping step or a spraying step, wherein the dipping step comprises dipping the male mold into the female mold solution for 5 to 15 seconds for 3 to 4 times so that the female mold solution is adhered to the outer surface of the male mold, and the spraying step comprises spraying the female mold solution onto the outer surface of the male mold for 5 to 15 seconds so that the female mold solution is adhered to the outer surface of the male mold; performing a drying step of drying the female mold solution on the outer surface of the male mold so as to form a portion of the female mold on the outer surface of the male mold; and repeating the adhesion step and the drying step for 3 to 4 times to form the female mold, wherein material of the female mold is light-transmitting; and dissolving the male mold by a solution to cause the remaining female mold to form the light-transmitting blood vessel model.

In an embodiment of the present disclosure, the male mold is formed by three-dimensional printing.

In an embodiment of the present disclosure, material of the male mold comprises acrylonitrile butadiene styrene (ABS), and material of the solution comprises acetone.

In an embodiment of the present disclosure, material of the male mold comprises polylactic acid (PLA), and material of the solution comprises chloroform and dichloromethane.

In an embodiment of the present disclosure, material of the male mold comprises polyvinyl alcohol (PVA), and material of the solution comprises water.

In an embodiment of the present disclosure, material of the male mold comprises nylon, and material of the solution comprises phenol, a saturated solution of calcium chloride in methanol, and concentrated formic acid.

In an embodiment of the present disclosure, material of the male mold comprises high density polyethylene (HDPE), and material of the solution comprises xylene.

In an embodiment of the present disclosure, material of the male mold comprises thermoplastic polyurethane (TPU), and material of the solution comprises dichloromethane.

In an embodiment of the present disclosure, material of the female mold comprises polydimethyl siloxane (PDMS).

In an embodiment of the present disclosure, the light-transmitting blood vessel model has an elongation ratio between 150 and 300%.

### DESCRIPTION OF DRAWING

FIGURE is a flowchart of a method of fabricating a light-transmitting blood vessel model according to an embodiment of the present disclosure.

### DETAILED DESCRIPTION OF PREFERRED EMBODIMENTS

The structure and the technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, and etc., are only directions by referring to the accompanying drawings, and thus the used directional terms are used to describe and understand the present disclosure, but the present disclosure is not limited thereto.

In an embodiment of the present disclosure, a method 10 of fabricating a light-transmitting blood vessel model comprises steps 11-13 of: providing a male mold, wherein a shape of the male mold corresponds to an inner space of a blood vessel (step 11); performing a female mold forming step to form a female mold on an outer surface of the male mold, wherein a shape of the female mold corresponds to a shape of the blood vessel, wherein the female mold forming step comprises: performing an adhesion step such that the female mold solution is adhered onto the outer surface of the male mold, wherein the adhesion step is a dipping step or a spraying step, wherein the dipping step comprises dipping the male mold into the female mold solution for 5 to 15 seconds for 3 to 4 times so that the female mold solution is adhered to the outer surface of the male mold, and the spraying step comprises spraying the female mold solution onto the outer surface of the male mold for 5 to 15 seconds so that the female mold solution is adhered to the outer surface of the male mold; performing a drying step of drying the female mold solution on the outer surface of the male mold so as to form a portion of the female mold on the outer surface of the male mold; and repeating the adhesion step and the drying step for 3 to 4 times to form the female mold, wherein material of the female mold is light-transmitting (step 12); and dissolving the male mold by a solution to cause the remaining female mold to form the light-transmitting blood vessel model (step 13). Details of the implementation and principles of the above-described steps of embodiments will be described in detail below.

Refer to figure. In an embodiment of the present disclosure, a method of fabricating a light-transmitting blood vessel model comprises a step 11 of: providing a male mold, wherein a shape of the male mold corresponds to an inner space of a blood vessel. In the step 11, data of the inner space of a blood vessel can be obtained by, for example, the following methods. For example, an appearance shape of the blood vessel can be obtained by any method in the prior art that can depict a three-dimensional image of the blood vessel. Further, the shape of the internal space of the blood vessel can be confirmed according to the appearance shape of the blood vessel and thickness of the wall of the blood vessel (for example, according to an average value of the thickness of the wall of a blood vessel of an object, or an average value of the thickness of the wall of the blood vessel from a medical point of view). In an embodiment, the male mold is formed, for example by three-dimensional printing. In another embodiment, material of the male mold can be, for example, acrylonitrile butadiene styrene (ABS), polylactic acid (PLA), polyvinyl alcohol (PVA), nylon, high density polyethylene (HDPE), or thermoplastic polyurethane (TPU). In an example, the thermoplastic polyurethane (TPU) is a mixture of hard segment chains and soft segment chains of isocyanate, which can be adjusted to TPU materials (also known as Flexible products) with different properties by ratios of soft and hard segments. Flexible products on the market include: Polymaker™ (trademark) from Polymaker, SemiFlex products and NinjaFlex products from NinjaFlex.

In an embodiment, an adhesive layer can be applied to the outer surface of the male mold to prevent the female mold solution described later from penetrating into an interior of the male mold. Material of the adhesive layer includes, for example, polyvinyl alcohol (PVA), sodium tetraborate decahydrate, and water. In an embodiment, a thickness of the glue layer is, for example, between 0.05 and 0.1 mm. In another embodiment, the adhesive layer is formed, for example, by coating on the outer surface of the male mold.

In an embodiment of the present disclosure, a method of fabricating a light-transmitting blood vessel model comprises a step 12 of: performing a female mold forming step to form a female mold on an outer surface of the male mold, wherein a shape of the female mold corresponds to a shape of the blood vessel, wherein the female mold forming step comprises: performing an adhesion step such that the female mold solution is adhered onto the outer surface of the male mold, wherein the adhesion step is a dipping step or a spraying step, wherein the dipping step comprises dipping the male mold into the female mold solution for 5 to 15 seconds for 3 to 4 times so that the female mold solution is adhered to the outer surface of the male mold, and the spraying step comprises spraying the female mold solution onto the outer surface of the male mold for 5 to 15 seconds so that the female mold solution is adhered to the outer surface of the male mold; performing a drying step of drying the female mold solution on the outer surface of the male mold so as to form a portion of the female mold on the outer surface of the male mold; and repeating the adhesion step and the drying step for 3 to 4 times to form the female mold, wherein material of the female mold is light-transmitting. In the step 12, the dipping step has specific steps, times and sequences. In one embodiment, the dipping step is to dip the male mold into a female mold solution for 5 to 15 seconds for 3 to 4 times. If it is less than 3 times (for example, 1 to 2 times), the female solution cannot be uniformly adhered to the surface of the male mold. This causes a part of the female mold to be formed unevenly when the drying step is performed, resulting in uneven thickness of the finally formed light-transmitting blood vessel model. If it is more than 4 times (for example, 5 to 10 times), the thickness of a part of the female mold is too thick, and finally, a light-transmitting blood vessel model having a blood vessel elasticity similar to that of the blood vessel is not formed.

In another aspect, if the time in the dipping step is less than 5 seconds, the female solution cannot be uniformly adhered to the surface of the male mold. This causes a part of the female mold to be formed unevenly when the drying step is performed, resulting in uneven thickness of the finally formed light-transmitting blood vessel model. On the other hand, if the time in the dipping step is more than 15 seconds, the thickness of a part of the female mold is too thick, and finally, a light-transmitting blood vessel model having a blood vessel elasticity similar to that of the blood vessel is not formed.

Similarly, the spraying step also has specific steps, times and sequences. In one embodiment, if the time in the spraying step is less than 5 seconds, the female solution cannot be uniformly adhered to the surface of the male mold. This causes a part of the female mold to be formed unevenly when the drying step is performed, resulting in uneven thickness of the finally formed light-transmitting blood vessel model. On the other hand, if the time in the spraying step is more than 15 seconds, the thickness of a part of the female mold is too thick, and finally, a light-transmitting blood vessel model having a blood vessel elasticity similar to that of the blood vessel is not formed.

In an embodiment, the drying step is performed, for example, at 30 to 40° C. (e.g., about 37° C.) until the part of the female mold is cured on the outer surface of the male mold. In another embodiment, the drying step is performed, for example, by an oven at about 40° C. until the part of the female mold is cured on the outer surface of the male mold.

In an embodiment, material of the female mold comprises, for example, polydimethyl siloxane (PDMS). In an example, the female solution comprises polydimethyl siloxane and a hardener, wherein a weight ratio of the polydimethyl siloxane to the hardener ranges, for example, from 5:1 to 50:1 (e.g., 10:1, 15:1, 20:1, 25:1, 30:1, 35:1, 40:1, or 45:1). In another embodiment, in a case where the material of the female mold includes, for example, polydimethyl siloxane (PDMS), the light-transmitting blood vessel model fabricated by the method of fabricating the light-transmitting blood vessel model in the embodiment of the present disclosure has an elongation ratio between 150 and 300%.

It is noted that the above adhesion step and drying step need to be repeated three to four times in order to form the female mold. In other words, the female mold is formed in batches, for example, in the case of repeating the adhesion step and the drying step three times, the female mold consists of a three-layer structure. Similarly, in the case of the adhesion step and the drying step is repeated four times, the female mold consists of a four-layer structure. The female mold formed in this manner can have an excellent stretch ratio (or elasticity). It is noted that the female mold formed by means of casting or pouring cannot achieve the elongation ratio as in the embodiment of the present disclosure. In other words, at least one feature of an embodiment of the present disclosure is to obtain a female mold having an excellent elongation ratio by a specific step, sequence, time, number of times, and the like of the dipping step or the spraying step.

In an embodiment of the present disclosure, a method of fabricating a light-transmitting blood vessel model comprises a step 13 of: dissolving the male mold by a solution to cause the remaining female mold to form the light-transmitting blood vessel model. In the step 13, since the female mold is formed on the outer surface of the male mold, the female mold that is not dissolved forms the light-transmitting blood vessel model after the male mold is dissolved through the solution. In other words, the material of the male mold corresponds to material of the solution. For example, in the case where the material of the male mold contains acrylonitrile butadiene styrene (ABS), the material of the solution contains acetone. In the case where the material of the male mold contains polylactic acid (PLA), the material of the solution comprises chloroform and dichloromethane. In the case where the material of the male mold comprises polyvinyl alcohol (PVA), and the material of the solution contains water. In the case where the material of the male mold comprises nylon, the solution is made of a phenol, a calcium chloride-saturated methanol solution, and a concentrated formic acid. In the case where the material of the male mold includes high density polyethylene (HDPE), and the material of the solution contains xylene, or in the case where the material of the male mold contains thermoplastic polyurethane (TPU), and the material of the solution contains dichloromethane. In one embodiment, the male mold is dissolved in the solution at 35 to 45° C. (e.g., about 40° C.) for 4 to 6 hours (e.g., about 5 hours) to cause the remaining female mold to form the light-transmitting blood vessel model.

Several embodiments are exemplified below so as to illustrate that the light-transmitting blood vessel model fabricated by the method of the embodiment of the present disclosure have an excellent stretch ratio.

### Embodiment 1

First, a male mold corresponding to an internal space in which a blood vessel is to be made is provided by a three-dimensional printing method, wherein material of the male mold comprises acrylonitrile butadiene styrene (ABS). Then, a dipping step is performed to dip the male mold into a female mold solution for about 5 seconds, and then to remove the male mold from the female mold solution. The aforementioned dipping and removing step is repeated 3 times. The female solution comprises polydimethyl siloxane and a hardener, wherein a weight ratio of polydimethyl siloxane to hardener is about 15:1. Thereafter, a drying step is performed to dry the female mold solution on the outer surface of the male mold at about 37° C. to form a part of the female mold. The dipping step and the drying step described above are repeated three times so as to form the female mold. Finally, the male mold is dissolved through acetone so that the remaining female mold forms the light-transmitting blood vessel model of Embodiment 1.

### Embodiments 2 and 3:

Embodiments 2 and 3 are fabricated in a manner substantially similar to that of Embodiment 1, except that the dipping step is about 10 seconds and about 15 seconds, respectively.

### Embodiments 4 to 6

Embodiments 4 to 6 are fabricated in a manner substantially similar to that of Embodiment 1, except that that the dipping step is replaced by a spraying step, wherein the spraying step is, for example, to spray a female mold solution onto the outer surface of the male mold for a period of about 5 seconds, about 10 seconds, and about 15 seconds, respectively.

Thereafter, a wall thickness and a stretch ratio of the light-transmitting blood vessel model are analyzed for Embodiments 1 to 6, wherein an analysis method of the stretch ratio is to measure a stretch ratio of a diameter of the light-transmitting blood vessel model. For example, the diameter is 19 mm when no external force is applied thereon. Then, a tensile force is applied in the direction of the diameter of the light-transmitting blood vessel model, and the diameter of the light-transmitting blood vessel model is 57 mm when broken. Therefore, the stretch ratio is 300%. Please refer to Table 1 below for the analysis results.

TABLE 1

| | | | Wall thickness | |
|---|---|---|---|---|
| | Time of | | of blood vessel | Stretch |
| | dipping step | | model | ratio |
| Embodiment 1 | 5 | seconds | 0.15 mm | 249.58% |
| Embodiment 2 | 10 | seconds | 0.18 mm | 221.96% |
| Embodiment 3 | 15 | seconds | 0.22 mm | 197.31% |
| | | | Wall thickness | |
| | Time of | | of blood vessel | Stretch |
| | spraying step | | model | ratio |
| Embodiment 4 | 5 | seconds | 0.28 mm | 146.57% |
| Embodiment 5 | 10 | seconds | 0.31 mm | 181.85% |
| Embodiment 6 | 15 | seconds | 0.43 mm | 159.43% |

From Table 1, the shorter the time of the dipping step, the thinner the wall thickness of the light transmitting blood vessel model and the better the stretch ratio. It can be seen from the above that the light transmitting blood vessel model obtained by the method of the embodiment of the present disclosure can change the wall thickness by modifying the time of the dipping step to further conform to an actual blood vessel state. In addition, the fabricated light-transmitting blood vessel model has an excellent stretch ratio, and the stretch ratio approximates an actual blood vessel stretch ratio. Therefore, the light-transmitting blood vessel model fabricated by the embodiment of the present disclosure can be made according to the actual blood vessel state to obtain a pseudovascular model.

In addition, the shorter the time of the spraying step, the thinner the wall thickness of the light-transmitting blood vessel model. It is noted that although Embodiment 5 (or Embodiment 6) has a thickness higher than that of Embodiment 4, the stretch ratio of Embodiment 5 (or Embodiment 6) is greater than that of Embodiment 4. However, it is noted that the stretch ratios of Embodiments 4 to 6 all have a stretch ratio similar to that of an actual blood vessel. It can be seen from the above that the light transmitting blood vessel model obtained by the method of the embodiment of the present disclosure can change the wall thickness by modifying the time of the spraying step to further conform to the actual blood vessel state. In addition, the fabricated light-transmitting blood vessel model has an excellent stretch ratio, and the stretch ratio approximates the actual blood vessel stretch ratio. Therefore, the light-transmitting blood vessel model fabricated by the embodiment of the present disclosure can be obtained according to the actual blood vessel state to obtain a pseudovascular model.

In another aspect, the light-transmitting blood vessel model obtained by the method of the embodiment of the present disclosure can be applied to a flow field visualization technology. For example, the light-transmitting blood vessel model is connected to a circulation motor, and a visualization liquid (for example, a liquid containing dyes having various colors) is introduced into the light-transmitting blood vessel model. Then, the flow state of blood in the blood vessel can be simulated by controlling the circulation motor (e.g., between 0 and 1500 mL/min, such as 100, 200, 300, 500, 700, 900, 1000, 1200 or 1400 mL/min). In the above visualization system, data such as flow velocity, flow rate, pressure, or wall stress can also be analyzed by an analysis device, so that it can be used to assist in judging a risk of vascular disease. In addition, the visualization system described above further includes an external flow field device (e.g., a soft tissue) located outside of the light-transmitting blood vessel model. The soft tissue can be used to simulate an interaction of blood flow in the blood vessels by adjusting its shape or properties. It can be seen from the above that the light-transmitting blood vessel model obtained by the method of the embodiment of the present disclosure can be applied to the flow field visualization technology, and the obtained analysis result approximates the actual condition of the blood vessel.

It is worth mentioning that the light-transmitting blood vessel model obtained by the method of the embodiment of the disclosure can also be applied to many industries, such as an education industry. For example, students in an internship can visually confirm a flow of blood in various blood vessels by the light-transmitting blood vessel model described above for use in flow field visualization techniques.

The present disclosure has been described with a preferred embodiment thereof and it is understood that many changes and modifications to the described embodiment can be carried out without departing from the scope and the spirit of the disclosure that is intended to be limited only by the appended claims.

1. A method of fabricating a light-transmitting blood vessel model, comprising steps of:
providing a male mold, wherein a shape of the male mold corresponds to an inner space of a blood vessel;
performing a female mold forming step to form a female mold on an outer surface of the male mold, wherein a shape of the female mold corresponds to a shape of the blood vessel, wherein the female mold forming step comprises:
performing an adhesion step such that the female mold solution is adhered onto the outer surface of the male mold, wherein the adhesion step is a dipping step or a spraying step, wherein the dipping step comprises dipping the male mold into the female mold solution for 5 to 15 seconds for 3 to 4 times so that the female mold solution is adhered to the outer surface of the male mold, and the spraying step comprises spraying the female mold solution onto the outer surface of the male mold for 5 to 15 seconds so that the female mold solution is adhered to the outer surface of the male mold;
performing a drying step of drying the female mold solution on the outer surface of the male mold so as to form a portion of the female mold on the outer surface of the male mold; and
repeating the adhesion step and the drying step for 3 to 4 times to form the female mold, wherein material of the female mold is light-transmitting; and
dissolving the male mold by a solution to cause the remaining female mold to form the light-transmitting blood vessel model.

2. The method of fabricating the light-transmitting blood vessel model according to claim 1, wherein the male mold is formed by three-dimensional printing.

3. The method of fabricating the light-transmitting blood vessel model according to claim 1, wherein material of the male mold comprises acrylonitrile butadiene styrene, and material of the solution comprises acetone.

4. The method of fabricating the light-transmitting blood vessel model according to claim 1, wherein material of the male mold comprises polylactic acid, and material of the solution comprises chloroform and dichloromethane.

5. The method of fabricating the light-transmitting blood vessel model according to claim 1, wherein material of the male mold comprises polyvinyl alcohol, and material of the solution comprises water.

6. The method of fabricating the light-transmitting blood vessel model according to claim 1, wherein material of the male mold comprises nylon, and material of the solution comprises phenol, a saturated solution of calcium chloride in methanol, and concentrated formic acid.

7. The method of fabricating the light-transmitting blood vessel model according to claim 1, wherein material of the male mold comprises high density polyethylene, and material of the solution comprises xylene.

8. The method of fabricating the light-transmitting blood vessel model according to claim 1, wherein material of the male mold comprises thermoplastic polyurethane, and material of the solution comprises dichloromethane.

9. The method of fabricating the light-transmitting blood vessel model according to claim 1, wherein material of the female mold comprises polydimethyl siloxane.

10. The method of fabricating the light-transmitting blood vessel model according to claim 9, wherein the light-transmitting blood vessel model has an elongation ratio between 150 and 300%.
